(19) United States
(12) Patent Application Publication
(10) Pub. No.: US 2023/0148703 A1
(43) Pub. Date: May 18, 2023

(54) METHOD OF DIMENSIONAL CHANGE OF THE FOOTWEAR SOLE AND THE FOOTWEAR WITH A SOLE OF VARIABLE DIMENSIONS

(71) Applicant: Kestutis REGELSKIS, Vilnius (LT)

(72) Inventor: Kestutis REGELSKIS, Vilnius (LT)

(21) Appl. No.: 17/995,450

(22) PCT Filed: Apr. 16, 2021
(86) PCT No.: PCT/IB2021/053145

§ 371 Date: Oct. 4, 2022

(30) Foreign Application Priority Data
Apr. 17, 2020 (LT) 2020 522

(51) Int. Cl. A43B 7/38; A43B 3/38

(52) U.S. Cl. CPC A43B 7/38; A43B 3/38; A61H 2003/001

(57) ABSTRACT

The invention relates to the field of the footwear industry, namely footwear (5) with a sole (6) of variable dimensions. The proposed method of dimensional change of the footwear sole (6) and the footwear (5) include a sole (6) of variable dimensions, the height of which may increase or decrease or return to the initial position, depending on the position of the sole (6) in contact with the supporting surface. The method of changing the height of the sole (6) of the footwear (5) proposed according to the invention facilitates climbing uphill, stairs, downhill, cycling by creating an effect of upward acting escalator without jerking or an effect of downward acting escalator without jerking, respectively.

### TECHNICAL FIELD TO WHICH INVENTION RELATES

The invention relates to the field of the footwear industry, namely to footwear with a variable-sized sole, the construction of which facilitates climbing uphill, stairs, downhill, cycling and elsewhere.

### INDICATION OF THE BACKGROUND ART

When stepping uphill or climbing stairs, to overcome gravity, muscle work must be performed that is equal to the product of body mass, free fall acceleration, and body lift height, i.e. E=m*g*h, where m is the mass of the body or a person with all objects, g is the acceleration of free fall, h is the height of the body's lift, and E is the gravitational potential energy of the body equal to the muscle work performed. Often in supermarkets, airports, where there is a large flow of people, escalators or conveyors are installed to facilitate climbing stairs or uphill. As it is not possible to install escalators everywhere, it is convenient to integrate such an “escalator” with footwear and use it when walking uphill or stairs.

There is a known step ascending and descending method for reducing the bearing capacity of the legs, where the auxiliary buffers are used for reducing the loading capacity of the legs in the step ascending and descending process of the human body. The auxiliary buffers are installed below soles of two feet and in a conventional state the heightening structural parts of the auxiliary buffers are compressed. In the step descending state, when the front foot descends from the step, an electronic switch is turned on, the heightening structural part is released and then the heightening structural parts are compressed under the action of the gravity of the human body.

The disadvantage of the known method is that the heightening structural parts lowers or raises the rear part of the foot. Also, according to the technical implementation of the auxiliary buffers, it is not possible to maintain a gradual compression of the raised heightening structural parts, which results in jerking. The known method and implementation for reducing the bearing capacity of the legs is described in Chinese Patent CN110075505 (A), 2019.

There is a known method and device for improving the movement and motor function of a human user by changing the inclination or standing height of the surface of the device to be placed on the user's leg while walking. The device includes a thrusting element placed between the sole and platform, a sensor and a processor.

The disadvantage of the known method and device is that the standing height of the surface of the device is changed during the swing phase of the gait. As a result, there is no elevator effect that makes it easier to climb stairs or uphill. The known method and device for improving the movement and motor function of a human user is described in U.S. Patent US2008134541 (A1), 2008.

There is a known power assisting device for climbing comprising a shoe sole, a shoe support, a power supply, an electric cylinder, a control module and a touch switch. A front plate protrudes upwards from the front end of the shoe sole, and the upper end of the front plate is movably connected with the front end of the shoe support through a pin shaft. When a person wearing the device climbs stairs or a slope, the shoe sole of one foot makes contact with the ground to switch on the touch switch, and then the control module sends out a signal to enable the electric cylinder rod of the electric cylinder to extend so as to make the rear portion of the shoe support rise gradually; when the foot is lifted up, the touch switch is switched off, and the control module enables the electric cylinder rod of the electric cylinder to be shortened, so as to make the rear portion of the shoe support fall gradually to recover to the original state.

The disadvantage of the known power assisting device for climbing is that the rear part of the shoe extends/recover and lifts only the rear part of the foot. These shoes only make the calf muscles easier to work, so climbing stairs does not strain the calf muscles, and over time, the calf muscles can weaken. Raising of the foot it is also limited due to the limited opening angle of the sole and the shoe holder. The known method and shoes are described in Chinese Patent CN107136624 (A), 2017.

There is a known apparatus for lifting in order to lift the carrying surface of at least one foot of a person who is going upstairs or downstairs at equal height with a next substantially horizontal step, wherein said apparatus comprises two surfaces for carrying and supporting, which are substantially parallel, which are arranged above each other, further comprising a lifting table and a control device for energizing said apparatus respectively at going upstairs or downstairs, wherein at going upstairs or downstairs said apparatus forms one body with said at least one foot and is carried away by said foot. The apparatus can reach two target positions, the first one a starting position at which carrying and supporting surfaces are substantially on top of each other, and the second one at which said surfaces have the biggest intermediate distance.

The disadvantage of the known apparatus for lifting is that the said apparatus is energized after the foot is placed on the surface of the apparatus, which is in one of the two starting positions, forming one body of said foot and said apparatus and as a consequence, after each such energizing of the device, a smooth climb up the stairs becomes jerky with each step. In other words, the foot starts to lift when it is already placed on the stairs and acceleration is felt with each step. The known apparatus for lifting is described in European Patent Application EP1661841A1, 2006.

### Technical Problem to be Solved

This invention aims to expand the functional properties of footwear by adapting it to climbing uphill, downhill and stairs, to facilitate when stepping at appropriate moments an increase and decrease in the height of the sole of the footwear with a constant speed is realized, which creates an effect of upward acting escalator without jerking. The invention also aims to improve sports footwear, which would facilitate the running of athletes on uphill, plain and downhill slopes.

### DISCLOSURE OF THE ESSENCE OF THE INVENTION

The essence of the solution of the proposed invention is that in a method to change the dimensions of the footwear sole in order to rise at least one foot of a person the dimensions of the sole of the footwear, preferably its height, are changed according to the position of the sole in contact with the supporting surface, where the height of the sole of the footwear of each foot varies under the following conditions:
a) the height of the sole starts to increase from its initial position or from position close to the initial position,

when the sole of the footwear approaches to the supporting surface closer than at a predetermined distance, or the sole already contacts the supporting surface, but still presses on the supporting surface with a force less than an acceptable predetermined force,

and when the sole is in contact with the supporting surface, sole height at all different points in its plane increases uniformly and at a constant speed, regardless of the force exerted by the sole of the footwear on the supporting surface, it at the same time raises the foot upwards;
b) the height of the sole stops to increase and returns to its initial position or close to the initial position, when the sole of the footwear no longer touches the supporting surface, wherein

the sequence of said stages a) and b) is repeated by walking, stepping, running, climbing, pedaling, jumping with one or both feet and where the change in the height of the sole of the footwear of each foot in stages a) and b) creates an effect of upward acting escalator without jerking.

In another embodiment of the proposed method to change the dimensions of the footwear sole in order to lower down at least one foot of a person the dimensions of the sole of the footwear, preferably its height, are changed according to the position of the sole in contact with the supporting surface, where the height of the sole of the footwear of each foot varies under the following conditions:
a) the height of the sole starts to decrease from its initial position or from position close to the initial position,

when the sole of the footwear approaches to the supporting surface closer than at a predetermined distance, or the sole already contacts the supporting surface, but still presses on the supporting surface with a force less than an acceptable predetermined force,

and when the sole is in contact with the supporting surface, sole height at all different points in its plane decreases uniformly and at a constant speed, regardless of the force exerted by the sole of the footwear on the supporting surface, it at the same time lowers the foot downwards;
b) the height of the sole stops to decrease and returns to its initial position or close to the initial position, when the sole of the footwear no longer touches the supporting surface, where

the sequence of said stages a) and b) is repeated by walking, stepping, running, climbing, pedaling, jumping with one or both feet and where the change in the height of the sole of the footwear of each foot in stages a) and b) creates an effect of downward acting escalator without jerking.

In another improvement the height of the sole of the footwear starts to vary when the vertical reaction force acting on said sole is less than 1 percent of body weight or is less than 5 percent of body weight, or less than 10 percent of body weight, or less than 20 percent of body weight, or less than 50 percent of body weight, or less than 100 percent of body weight.

The dimensions of the sole of the footwear only varies in the direction of gravity, regardless of the inclination of the supporting surface.

In a constructive embodiment of the present invention the footwear with variable sole dimensions, comprising a footwear body and a sole attached thereto, having an upper sole part and a lower sole part, between which at least one motorized actuator is mounted to change the dimensions of the sole according to the signals received from the position detection means for detecting contact with the supporting surface, a control electronics, and a power supply, wherein the motorized actuator, with a linear transmission function, consists of a lifting scissor mechanism which is coupled in a plane of motion perpendicular to it and kinematically interacts with an analogous driving scissor mechanism, in which the distances between the fulcrum are equal to or twice less than the distances between the fulcrum in the lifting scissor mechanism, the drive scissor mechanism is connected via a system of pulleys by a rope to a drive pulley driven by a constant speed electric motor with a reduction gear, and when the lower part of the sole is in contact with the supporting surface, the rotational speed of said electric motor is kept constant regardless of the variation of the load.

The upper part and the lower part of the sole of the footwear each consists of at least two separate parts, wherein the separate parts of the upper part of the footwear sole are connected to each other by hinges with the pivot axis.

An angle between the planes of rotation of two adjacent pulleys is freely variable by aligning the pivot axis of said planes with the rope connecting said two adjacent pulleys and.

The rope is a UHMWPE rope, or an aramid rope.

The position detection means are elongated in shape, are flexible and generate signals when they are bent or compressed, said means are located in the lower part of the sole.

The electric motor operates in the generator mode when the height of the sole of the footwear decreases under the influence of body weight and the performed gravity work is used to charge the power supply.

### Advantages of the Invention

The advantage of the proposed invention is that the repetitive increase in the height of the footwear sole and the lifting of the human foot at a constant speed when the foot rests on the supporting surface, and the return of the footwear sole to the initial position when the foot is moved, creates an effect of upward acting escalator without jerking, where at every step a person is lifted upwards and climbing uphill or stairs upwards requires no effort, the experience is felt as if walking on a horizontal surface.

It is desirable for said footwear, which facilitates climbing uphill and stairs, to be worn on both feet, however, according to the proposed invention, this method is effective even when wearing said footwear on only one foot.

Also according to the proposed invention, this method and footwear make it easier to jump uphill or up stairs when you making a take-off with both feet at the same time, while both feet touch the supporting surface and make a take-off, the height of the soles of the footwear increases and lifts both feet and the person up, and while flying in the air and the feet are not touching the supporting surface, the soles of the footwear contract back to their original position, after which the sequence of operations is repeated again during the next jump.

In addition, the supporting surface is any surface on which the human foot rests and the sole of the footwear, respectively. Examples of the supporting surface are: sidewalk, path, stairs, asphalt, sand, grass, floor, platform, bicycle pedals, ladders, etc.

Moreover, the said footwear may be any shoes, sandals, slippers, sneakers, high heels, etc., with variable size soles, preferably variable height soles, or variable height platforms and other devices attached to the foot or leg which can be worn on the foot and which can raise/lower the foot and at the same time a person.

This invention also facilitates pedaling, preferably bicycle pedaling, when pedaling is enhanced due to repeated increases in the height of the sole of the footwear when pedaling and the return of the sole height to the initial position when the pedal is returned and cycling is greatly facilitated, less muscle work is required when pedaling bicycle pedals.

This invention also facilitates climbing the ladder.

Also, the kinematics and dynamics of the change in the height of the different parts of the sole of the footwear can be adjusted depending on whether you are climbing stairs or on exactly the same slope path, e.g. stairs and near the stairs the same slope path for pushing the trolley, the slope is the same in both cases, but the gradient of the relief is different, in other words, the inclination of the supporting surface under the sole.

Also the dimensions of the sole of the footwear can be changed only in the direction of gravity, regardless of the inclination of the supporting surface.

When climbing a 10% slope (slope=height/distance *100%) and if the step length is about 0.5 m, the change in the height of the sole of the footwear must be approximately 50 mm to fully compensate for the slope. If you run, the length of the steps is longer, but the foot touches the supporting surface for a shorter period of time and as a result the change in the height of the sole changes little.

In addition, with the use of variable sole height sneakers, uphill running is as easy as on a plain, and running on a plain can artificially create a downhill effect and significantly increase running speed without additional physical effort.

Another advantage of the proposed invention is that the repetitive decrease in the height of the sole of the footwear and the lowering of the human foot at a constant speed when the foot rests on the supporting surface and the increase in the height of the sole of the footwear when the foot is moved, creates an effect of downward acting escalator without jerking, when at each step a person is lowered down and descending a slope or stairs down is comfortable, the feeling experienced is as if walking on a horizontal surface.

In addition, descending downhill or stairs due to gravity reduces the potential energy of the human body, and the actuators operate in generator mode and the released potential energy of the human body can be used to charge the footwear batteries.

The usefulness of the proposed invention is manifested in walking uphill or downhill of any steepness, climbing stairs down and up, walking on plains, etc., as well as when running, stepping, jumping with one and both feet, footwear with repetitive variable height soles create an effect of upward or downward acting escalator without jerking, which effectively changes the slope of the supporting surface, which may be decreasing or increasing, or there may not be any slope effectively.

The invention is explained in detail by drawings, which do not limit the scope of the invention and which show the following:

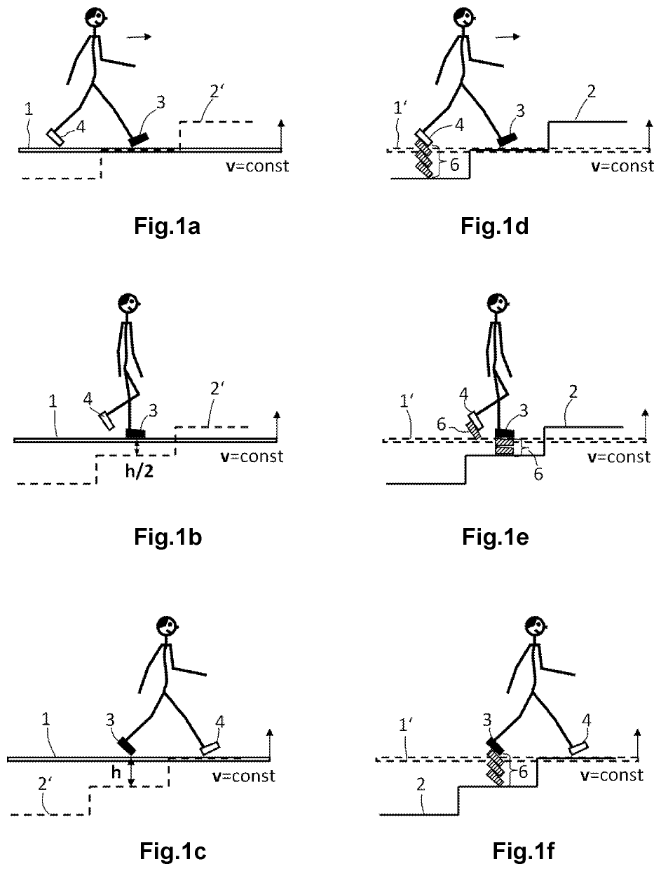

FIG. 1a-FIG. 1f—schemes illustrating a proposed method that facilitates stair climbing using variable sole height footwear.

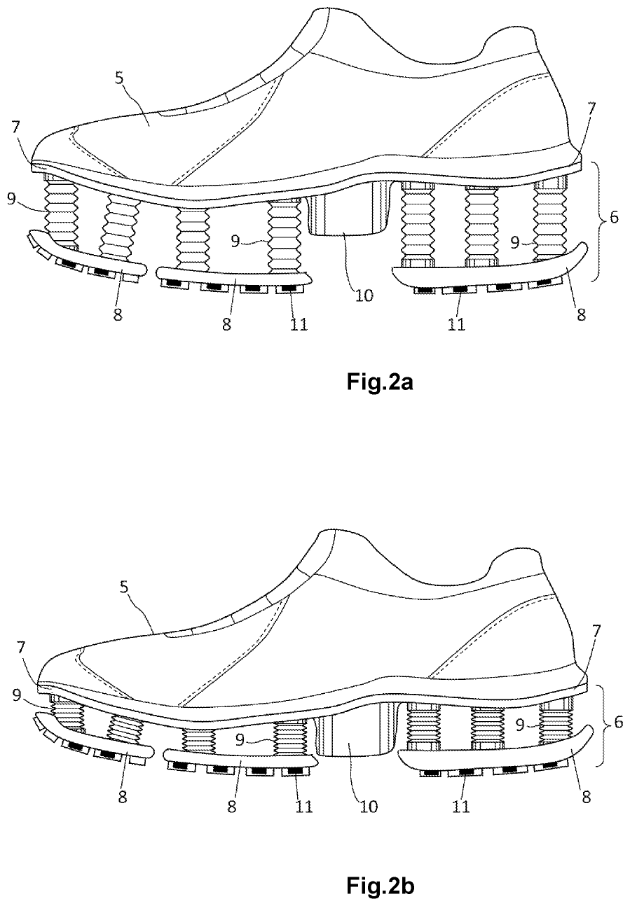

FIG. 2a-FIG. 2b—schemes illustrating a variable sole height footwear with openly visible linear actuators.

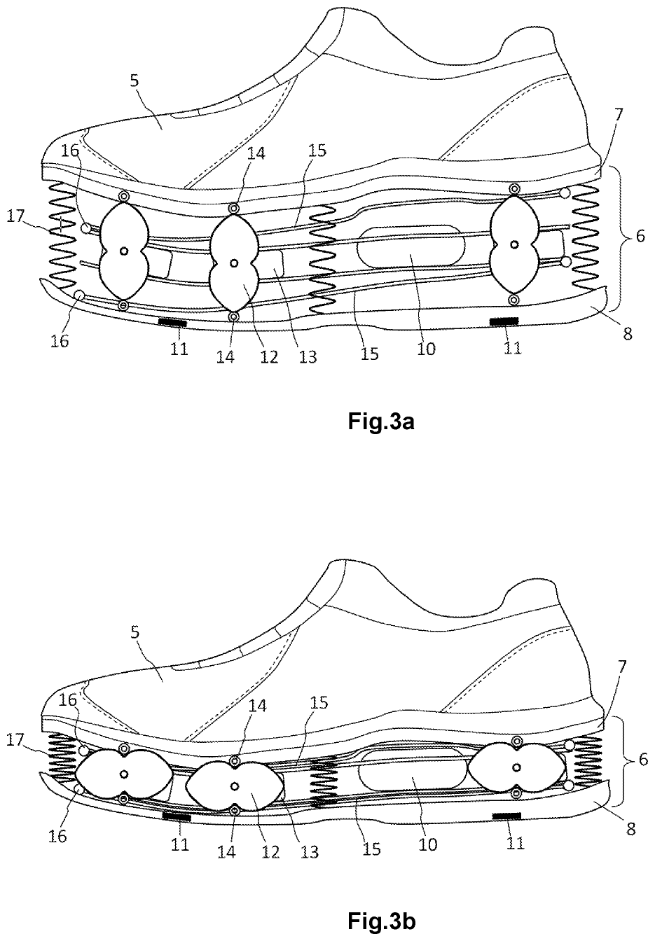

FIG. 3a-FIG. 3b—schemes illustrating variable sole height footwear with an open inner sole construction in which the actuators consist of Archimedean helical rotors driven by servomotors.

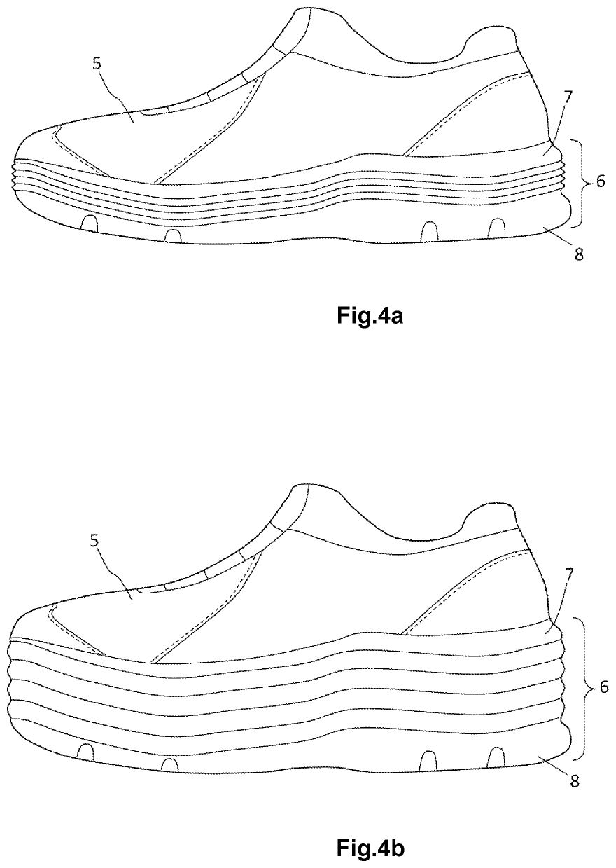

FIG. 4a-FIG. 4b—shows the outside of the variable sole height footwear and the inner structure of the sole is hidden.

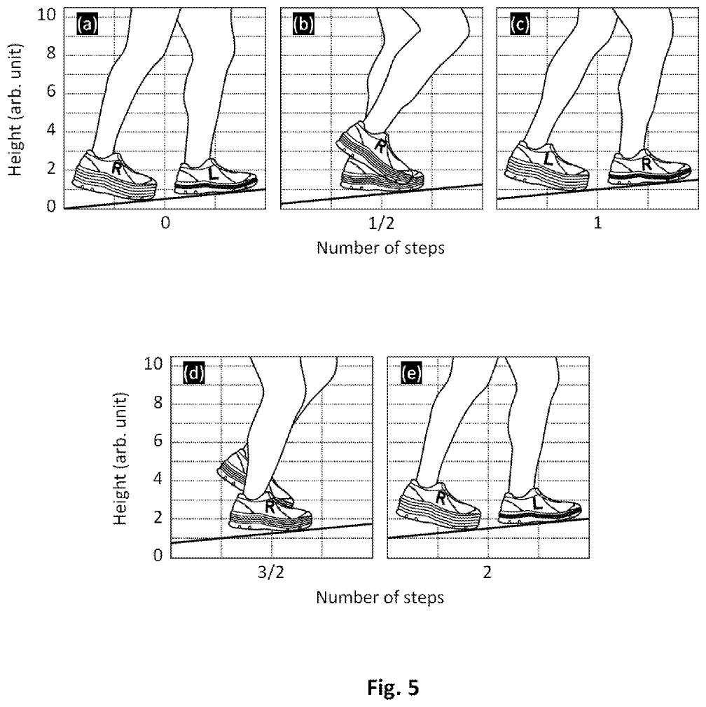

FIG. 5—shows diagrams of climbing uphill with variable sole height footwear at different step moments.

FIG. 6—shows the dependence of the change of the heights of the soles of the footwear worn on the left and right feet on the time when a person walks slowly uphill.

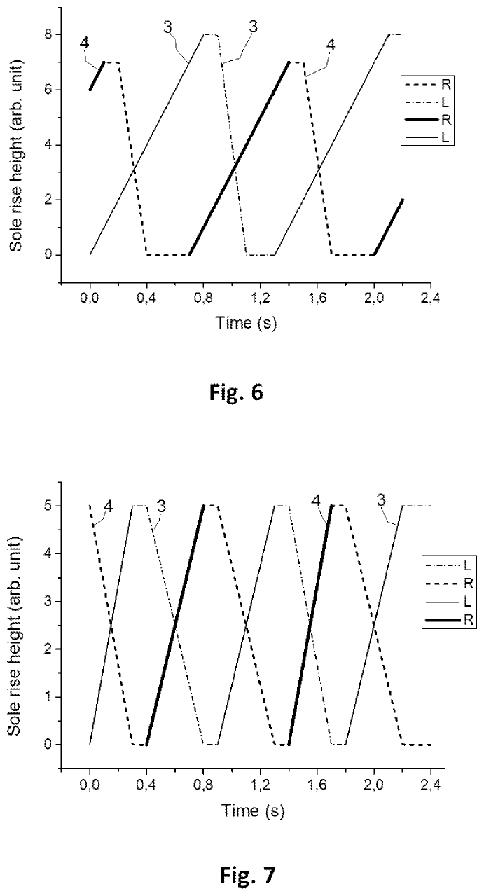

FIG. 7—shows the dependence of the height change of the soles of sneakers worn on the left and right foot on the time when a person is jogging uphill.

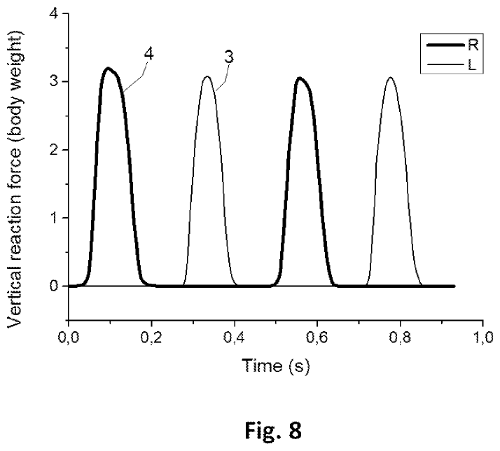

FIG. 8—shows the vertical reaction force of a sprint athlete to the soles of sneakers depending on the time.

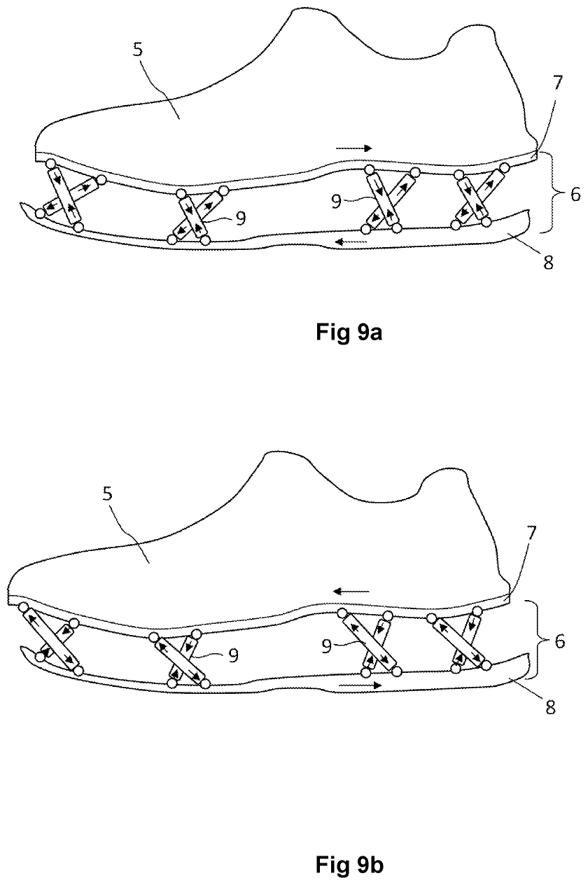

FIG. 9a-FIG. 9b—show schemes of variable size sole with diagonally and anti-diagonally arranged actuators.

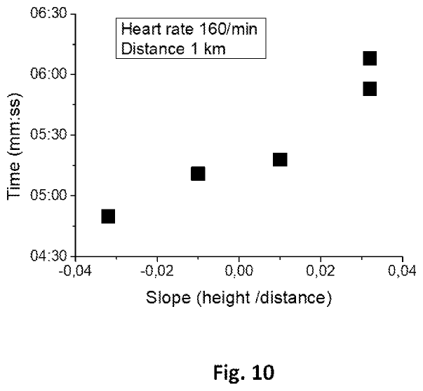

FIG. 10—shows the dependence of running speed on the slope when maintaining a constant heart rate.

FIG. 11—shows a detailed diagram of the variable height sole, shown from below.

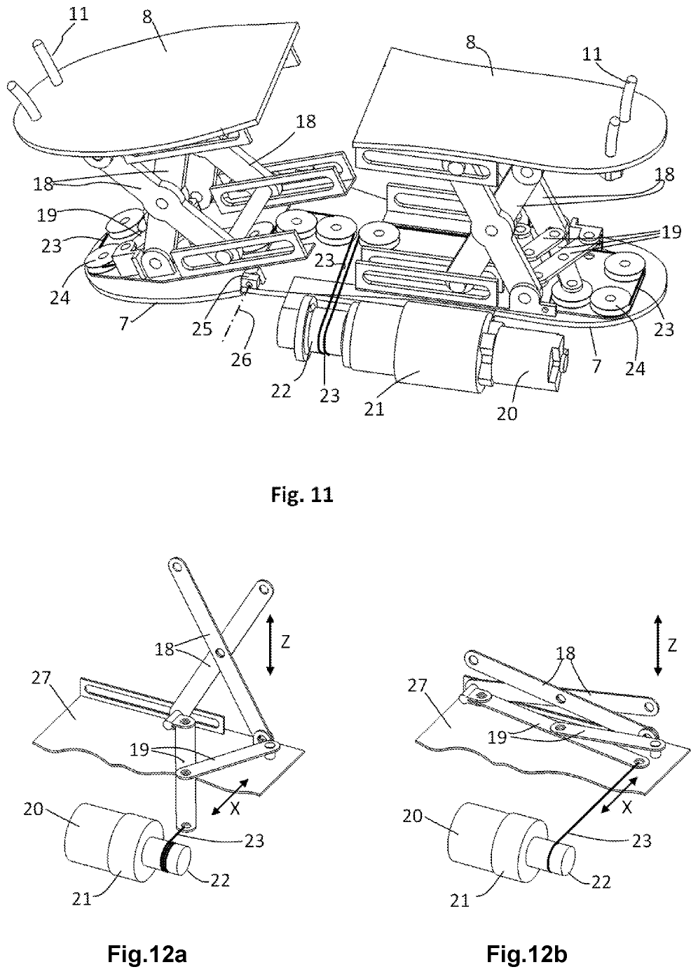

FIG. 12a-FIG. 12b—show perpendicularly coupled scissor mechanisms driven by an electric motor.

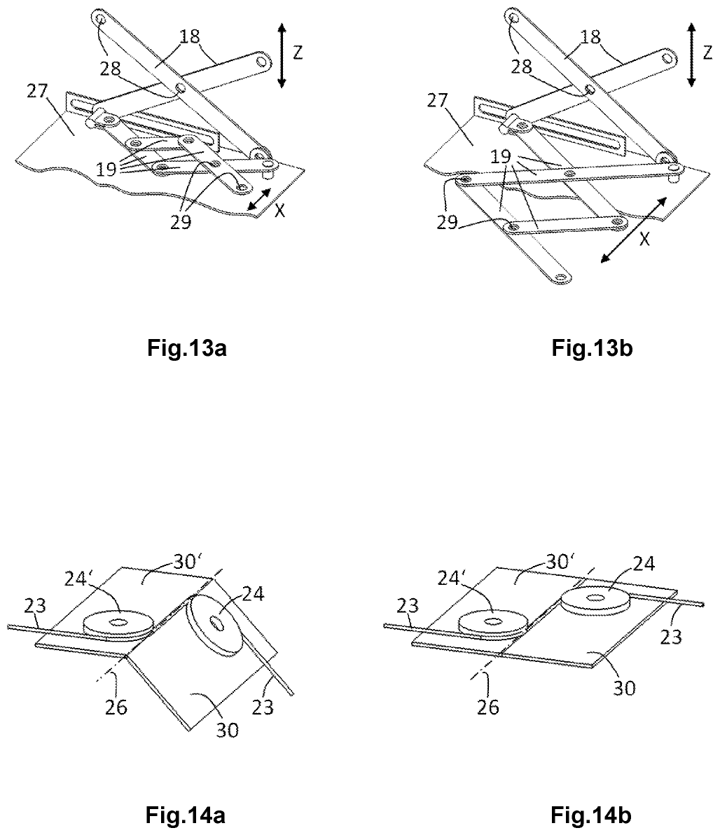

FIG. 13a-FIG. 13b—show perpendicularly coupled scissor mechanisms with transmission functions Z=2 X and Z=1/2 X, respectively.

FIG. 14a-FIG. 14b—show the passage of a rope between two adjacent pulleys when the angle between the planes of rotation of these two adjacent pulleys is freely variable.

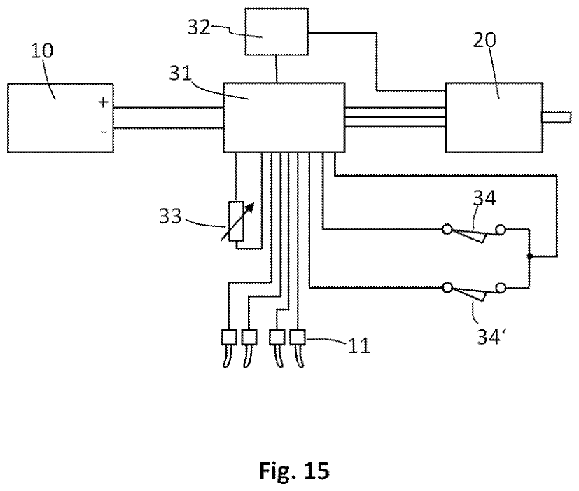

FIG. 15—shows a block diagram of an electric motor speed control.

Abbreviations used in the drawings:

L—left leg, left foot or left footwear;

R—right leg, right foot or right footwear.

### EXAMPLES OF REALIZATION OF THE INVENTION

According to the proposed invention, when a person wears footwear with variable soles and climbs a hill or stairs, while the foot and the footwear sole are in contact with the supporting surface (foot stance phase), the height of the footwear sole increases and raises the foot and the person upwards at a constant speed, and while the sole of the footwear does not touch the supporting surface and the foot is moved (foot swing phase), the height of the sole of the footwear returns to its initial position, after the foot has been moved, when the foot and the sole of the footwear respectively come into contact with the supporting surface again, the height of the sole of the footwear increases again and raises the foot and the person upwards at a constant speed, this sequence of operations of expansion and contraction of the sole of the footwear is repeated with each step until climbing uphill or stairs and creating an effect of upward acting escalator without jerking, which effectively changes the slope of the uphill or stairs and can create a feeling as if walking on a horizontal surface. Meanwhile, by stepping downhill or down the stairs, every step when the foot touches the supporting surface, the height of the sole can be reduced, and while the foot is moved, the height of the sole is returned to its original position, thus facilitating walking downhill or down stairs, creating the feeling of stepping on a horizontal surface. It is desirable that footwear with a variable sole height be worn on both feet.

The proposed method for facilitating stair climbing when wearing variable sole height footwear is schematically explained in FIG. 1. On the left side FIG. 1 a-c shows a person walking from left to right on platform 1 rising at a constant speed (v=const), next to the rising platform 1 a dashed line shows an imaginary staircase 2′. Initially (FIG. 1 a), the left foot 3 and the right foot 4 are placed on the platform 1, the left foot 3 is placed at the middle imaginary step 2′. By moving the right foot 4 forward, the platform 1 rises at a constant speed and at the moment shown in FIG. 1 b, the platform 1 and the left foot 3, respectively, are raised to a height h/2 by half of the imaginary stair 2′. Further, while a person moved his right leg 4 and placed it on the platform 1 or the next imaginary stair 2′, during this time the constantly rising platform 1 rose to a height h through one imaginary stair 2′. Looking at FIG. 1 a-c, we notice that a person walking on a constantly rising platform 1 places his left foot 3 on an imaginary middle step 2′ and this placed-left foot 3 rises vertically upwards through one imaginary step 2′, the next step repeating the sequence of operations, but with another—right foot 4, etc. The figures on the right (FIG. 1 d-f) show a person climbing a staircase 2 and an imaginary platform 1′ rising next to him at a constant speed, and variable height soles 6 are attached to the human feet 3, 4, or, analogously, a person wearing variable sole height shoes. Initially (FIG. 1 d) the left foot 3 is placed on the middle step 2 and the right foot 4 is raised and placed on the lowest step 2, the height of the sole 6 mounted on the right foot 4 is such that the right and left feet are at the same height. By moving the right foot 4, the left foot 3 is raised at the speed of the sole 6 so that the left foot 3 rises together with the imaginary platform 1′, while the sole 6 attached to the right foot 4 contracts. When the right foot 4 is moved and placed on the next step 2, the height of the sole 6 attached to the left foot 3 changes so that the right and left feet are at the same height. As we can see, climbing stairs while wearing shoes with a variable sole height can make you feel as if you are walking on the surface of a horizontal and constantly rising platform. This thus creates an effect of upward acting escalator without jerking, creating an impression that changes the slope of the stairs.

Meanwhile, when climbing down the stairs, in contrast to the case discussed above, the foot placed on the stairs at each step is lowered, thus creating an effect of downward acting escalator without jerking, as a result of which the slope of the stairs is effectively changed and climbing the stairs down can cause a feeling as if walking on a horizontal supporting surface.

To prevent jerking when stepping, the height of the sole begins to change when the foot touches the supporting surface or just before touching the supporting surface and the height of the sole changes until the foot rises into the air and the sole no longer touches the supporting surface.

Also, in order to prevent feeling of fluctuations when stepping, the height of the sole of the shoe changes at a constant speed. However, when jumping, taking-off with both feet, or running, it can be beneficial to increase the height of the soles of a variable speed shoe, creating a greater resistance force.

FIG. 2 a and FIG. 2 b show a variable height sole footwear 5 consisting of a variable height sole 6 having an upper sole part 7 and a lower sole part 8, actuators 9 are mounted between the upper sole part 7 and the lower sole part 8, by means of which the height of the sole 6 is changed, a power supply 10 is installed in the footwear 5 to supply the actuators, and means 11 for detecting the position of contact with the supporting surface are mounted in the lower part 8 of the sole which, depending on the position of the contact with the supporting surface, generates output signals and transmits them via the control electronics to actuators 9, which change the dimensions of the shoe sole 6 accordingly depending on the received signals. The dimensions of the sole 6 of the footwear 5 are changed when the sole 6 of the footwear 5 is in contact with the supporting surface or the sole 6 moves toward to the supporting surface and it is closer than within a predetermined distance. The dimensions of the sole 6 of the footwear 5 return to the original position or close to it when the sole 6 of the footwear 5 no longer touches the supporting surface. Said means 11 of detecting contact with the supporting surface may be selected from the group consisting of pressure sensors, strain gauges, ultrasonic or electromagnetic distance sensors, that can be analogous to parking sensors, accelerometers that measure foot acceleration, gyroscopes that measure foot incline, switches built into the soles of the footwear which are pressed when approaching or touching the supporting surface with the foot.

Also, the shoe control electronics can be additionally linked and can receive signals optionally from the uphill steepness determining means, step parameter determining means, terrain gradient determining means and transmit these signals according to a predetermined need to the actuators 9, which, according to the additional control signals received, adjust the lifting height and speed of the sole 6, set the inclination between the lower sole part 8 and the upper sole part 9, raise the heel area more than the rest of the foot.

FIG. 2 a shows footwear with a variable height sole extended, and FIG. 2 b shows shoes when the variable height sole is retracted.

The actuators 9 are mounted on the footwear sole 6 so that one side of each actuator 6 rests on the upper sole part 7 closer to the foot and the other side rests on the lower sole part 8 closer to the supporting surface or rests directly on the supporting surface to form the lower sole part 8. The sole of the shoe is fitted with at least one actuator 9. Also, the lower sole 8 can be made up of several parts and each part is individually controlled electronically depending on the walking or running style, the slope and the terrain gradient.

Said actuators 9 may be selected from the group consisting of hydraulic actuators, pneumatic actuators, electromechanical actuators, piezoelectric actuators, segmented spindle actuators, rigid chain actuators, rigid belt actuators, helical band actuators, rack and pinion mechanisms, twisted and coiled polymer (TCP) actuators, linear electric motors, roller screw actuators, electroactive polymers, servomechanisms, etc.

Said power supplies 10 may be rechargeable lithium-ion batteries, lithium polymer batteries, lithium-air (Li-air) batteries, nickel (NiMH) batteries, or disposable lithium metal batteries, alkaline batteries, etc. If high instantaneous power is required, a supercapacitor can be used with the battery.

The above-mentioned means for determining the slope and step parameters are a 3-axis accelerometer to measure acceleration and to determine the position of the foot in space and to determine the slope or orientation sensor module, comprising a 3-axis gyroscope, a 3-axis accelerometer and a 3-axis magnetometer to determine the position and direction and their change, and the slope of the hill is determined accordingly.

The means of determining the slope of the hill can also be realized by the difference between the heights of the right and left feet by stepping, when a directional-sensitive radio or optical or ultrasonic communication is established between the left and right feet; according to the peculiarities of the connection, the microprocessor calculates the difference in the height of the feet and, accordingly, the steepness of the uphill or staircase.

Determining the steepness of the uphill or staircase is simply done manually, when walking uphill or stairs, a person assesses their steepness, and the footwear can be controlled by phone via Bluetooth or can be controlled by remote control by transmitting control signals to the footwear electronics by radio, the control panel can be mounted on a ring or bracelet, or simply held in the palm of your hand. It is practically enough for a person to control only one parameter, and at which moments and at what speed the height of the soles of the footwear must change is specified by the control electronics.

FIG. 3 a and FIG. 3 b show a schematic diagram of a variable-height sole footwear with an open inner sole structure, the actuators placed in the sole 6 consists of Archimedean spiral rotors 12, which are driven by servomotors 13. The shape of the rotor 12 is chosen so that its diameter is proportional to the angle of rotation, namely the Archimedean spiral, and has this property. To reduce friction, the rotors 12 rest on bearings 14 mounted in the upper sole 7 and the lower sole 8. If the bearings 14 are large enough, then the shape of the rotors 12 must be slightly adjusted so that the height of the sole 6 varies in proportion to the angle of rotation of the rotors 12. The upper sole 7 is connected to the lower sole 8 by linkages 15, hinges 16 and springs 17. A power supply 10 is provided in the footwear sole 6 for powering the servomotors 13, and a position detection means 11 is provided in the lower part 8 of the sole for detecting the contact of the foot with the supporting surface. The footwear also includes control electronics that control the actuator depending on the slope and step parameters. FIG. 3 a shows footwear with the variable height sole extended, and FIG. 3 b shows footwear when the variable height sole is retracted.

FIG. 4 a and FIG. 4 b show a variable sole height footwear 5 when the height of the sole 6 is low (FIG. 4 a) and high (FIG. 4 b), respectively. Actuators for changing the height of the sole 6 are mounted between the upper sole part 7 and the lower sole part 8.

FIG. 5 shows the variation in the height of the feet and the shoe soles depending on the number of steps when going uphill, in the figures the letter R denotes the right foot or shoe and the letter L denotes the left foot or shoe. In the initial position (FIG. 5 a), when the number of steps is zero, the left foot is placed at the front and the right foot is placed at the rear. The height of the sole of the right foot shoe is greater than the height of the sole of the left foot shoe so that both feet are at the same height. When moving the right foot, the height of the sole of the left foot shoe increases evenly, and the sole of the right foot shoe contracts (FIG. 5 b). When the right foot is put, the height of the sole of the left foot shoe increases evenly to such an extent that both feet are again at the same height (FIG. 5 c). Further taking the second step, the right foot stands still and the height of the sole of its shoe increases steadily, while the left foot is moved and the sole of its shoe contracts (FIG. 5 d) and finally, until the left foot is put, the height of the shoe sole of the right foot increases evenly to such an extent that both feet are again at the same height (FIG. 5 e). As we can see after two steps, the feet are raised one division upwards (in the direction of the ordinate axis) and because, due to the change in the height of the sole of the shoe, the movable foot is placed at the same height as the standing foot, the uphill steepness effectively becomes zero.

FIG. 6 shows the dependence of the change in the heights of the soles of the footwear worn on the left and right feet on the time when a person walks uphill in a slow step. When the left foot 3 is placed on the supporting surface (0 seconds), the height of the footwear sole of the left foot 3 increase evenly (solid thin line), while the right foot 4 is moved (0.1 seconds), the height of the sole of the right foot 4 of the footwear begins to decrease (0.2 seconds) and returns to the starting position (dashed thick line) (0.4 seconds). As the height of the footwear sole of the left foot 3 continues to increase, the moved right foot 4 is placed on the supporting surface and the height of the footwear sole of the right foot 4 increase evenly (thick solid line) (0.7 seconds), after the left foot is raised and moved, the height of the sole of the footwear of the left foot 3 stops increasing (0.8 seconds), after which time it begins to decrease (0.9 seconds) and contracts (dashed dotted line) (1.1 seconds).

After the moved left foot 3 is placed on the supporting surface (1.3 seconds), the sole of the footwear of the left foot 3 evenly rise again (thin solid line), and so on. Thus, when the foot is placed on the supporting surface, the height of the sole of the footwear increases evenly, and when the foot is moved, then the height of the footwear sole decreases and returns to the initial position. When walking, a certain period, both feet rest on the supporting surface and both feet of the footwear soles rise together.

The change in the height of the sole of the footwear depends on the moments when the foot touches and does not touch the supporting surface, and is controlled by the position detection means 11 for detecting contact with the support surface. The effect of upward acting escalator can also be realized without the use of the means 11 of detecting the position of the contact with the supporting surface. The simplest way to realize an effect of upward acting escalator is to synchronize the steps with the soles of the footwear that changes periodically. As the height of the sole of the footwear increases (FIG. 6 solid line, thin or thick), the foot and the sole of the footwear, respectively, must rest on the supporting surface, and at the same time as the sole height decreases (FIG. 6 dashed or dotted line), the foot and the sole of the footwear, respectively, must not touch the supporting plane, and the more precisely the steps are synchronized with the stages of the height change of the sole of the footwear, the greater the lifting effect is achieved. If synchronization is not achieved, for example, half the time the sole of the footwear raises the foot up and the other half time allows it to go down until the foot rests on the supporting surface, then there will be no lifting effect. Conversely, if the foot rests on the supporting surface when the sole height decreases and the foot does not rest on the supporting surface when the sole height increases, then an effect of downward acting escalator will be created. Synchronization can be achieved by the person himself by stepping in stroke with periodically variable height soles, or synchronization means can be provided that adjust the period and phase of the footwear sole to the parameters of the person's step. The phases of the change in the height of the sole of the footwear of the left and right foot must also be coordinated, the phases must differ by half the period, that is, when the height of the sole of the footwear of one foot increases, the height of the sole of the footwear of other foot must decrease. Phase-to-phase matching can be ensured by using radio communication between the left and right foot footwear.

FIG. 7 shows the dependence of the change in height of the soles of sneakers worn on the left and right foot on the time a person is jogging uphill. When the left foot 3 or the right foot 4 touches the supporting surface, then the height of the sole of the sneaker on the left foot 3 or the right foot 4 increases evenly (solid lines), and when the foot is moved, then the sole of the sneaker returns to its initial position (dashed or dashed and dotted lines). The regularity of the change in the height of the soles of sneakers worn on the left foot 3 and the right foot 4 during running is similar to that in the case of walking (FIG. 6), the main difference is that the supporting surface is touched only by the right foot 4 or the left foot 3, or both feet are in the air for a period of time and do not touch the supporting surface.

FIG. 8 shows the vertical reaction force to the soles of sneakers caused by a sprint athlete depending on time. During sprinting, when the foot is placed on the supporting surface, the vertical reaction force on the sole of the sneaker at certain moments of time is more than three times greater than the athlete's body weight, as a result, running sneakers must be equipped with actuators capable of lifting at least three times the weight of the athlete. Meanwhile, the vertical reaction force on the soles of sneakers of basketball players performing a jump is up to nine times greater than the weight of the basketball player.

Another improvement according to the proposed invention is that in the method of footwear facilitating climbing uphill and stairs, comprising footwear of variable sole dimensions with human stepping, while the foot and the sole of the footwear respectively contact the supporting surface, the lower part of the sole slides horizontally with respect to the foot, in the direction opposite to the direction of walking, and when the foot is moved, the lower part of the sole returns to the initial position, after the foot and the sole of the footwear respectively touch the supporting surface again, the lower part of the sole slides horizontally again with respect to the foot in the opposite direction of walking, and this sequence of operations is repeated with every step. Repeated horizontal displacement of the sole of the footwear with respect to the foot increases the stepping speed, creating a feeling as if walking on a sliding path. In the construction implementation (FIG. 9), the footwear comprises actuators arranged diagonally at different angles, by means of which not only the height of the sole of the footwear but also the horizontal displacement of the lower part of the footwear sole with respect to the upper part of the sole or the foot is changed. FIG. 9 a and FIG. 9 b show footwear 5 with variable sole dimensions consisting of a variable sole 6 having an upper sole part 7 and a lower sole part 8, diagonally and anti-diagonally oriented actuators 9 are mounted between the upper sole part 7 and the lower sole part 8, by means of which not only the height of the sole 6 is changed, but also the lower part 8 is moved horizontally with respect to the upper sole part 7. The lower sole part 8 is displaced horizontally with respect to the upper sole part 8 when the diagonally arranged actuators contract or expand, while the anti-diagonally arranged actuators, on the contrary, expand or contract. During stepping, sliding the soles horizontally increases the speed of movement, creating the effect of a sliding path. FIG. 9 a shows the footwear 5 when the lower sole 8 is moved horizontally forward with respect to the upper sole 7, and FIG. 9 b shows the footwear 5 when the lower sole 8 is moved horizontally backwards. In order for the lower sole 8 to be displaced horizontally with respect to the upper sole part 7, at least two actuators are required which are inclined at different angles to each other.

The horizontal displacement of the lower sole part 8 of the footwear 5 with respect to the upper sole part 7 can also be realized by using a horizontal linear actuator or horizontal rails. Said horizontal linear actuator may be a displacement table, a linear electric motor, a piezo actuator, etc. The footwear 5 is also provided with a means 11 for detecting the position of contact with the supporting surface, control electronics, power supply 10. The control electronics can be additionally linked and can receive signals optionally from the uphill steepness determining means, step parameter determining means, terrain gradient determining means and transmit these signals according to a predetermined need to the actuators 9, which, according to the additional control signals received, adjust the lifting height and speed of the sole 6, set the inclination between the lower sole part 8 and the upper sole part 7.

To prevent jerking when stepping, the lower sole part 8 of the footwear 5 starts to slide horizontally with respect to the upper sole part 7 at the moment when the lower sole part 8 touches the supporting surface or just before touching the supporting surface and the lower sole part 8 moves horizontally until the foot rises into the air and the sole no longer touches the supporting surface. Also, in order not to feel any fluctuations when stepping, the lower part 8 of the sole of the footwear slides horizontally at a constant speed with respect to the foot or the upper part 7 of the sole. However, when jumping with both feet, or running, a horizontal sliding of the bottom of a variable speed footwear sole can be beneficial, thus creating a greater pushing force.

FIG. 10 shows the dependence of running speed on uphill steepness when a constant heart rate is maintained. It was measured how long it takes to run a distance of 1 km uphill while maintaining a constant heart rate of 160/min. As we can see in the figure, the running time is almost proportional to the steepness of the hill. When the uphill steepness was 0.032, the 1 km distance was run in an average of 6 min, while when running downhill of the same steepness, the 1 km distance was run in 4 min and 50 s. Assuming that the step length is about 1 m during jogging and the foot rests on the supporting surface in less than half the time in one step, then the change in the height of the soles of the sneakers in the range of less than 30 mm fully compensates for the uphill. Also, based on the data presented in FIG. 10, we see that an effective means of determining the uphill steepness may be a heart rate monitor measuring the heart rate and an accelerometer module for measuring the step parameters. At a constant step length and speed, the heart rate depends on the uphill steepness, according to which the microprocessor selects the parameters of the height change of the sneaker sole. The heart rate monitor can be mounted in a sneaker, or in another location, e.g. on the wrist or chest.

FIG. 11 depicts a detailed diagram of the variable height sole, shown from below. The two actuators placed between the upper sole part 7 and the lower sole part 8 consist of lifting scissor mechanisms 18 which are coupled perpendicularly to analogous driving scissor mechanisms 19. The perpendicular coupling of the scissor mechanisms enables a horizontal displacement of the driving scissor mechanism 19 with respect to the plane of the sole part 7, proportional to the vertical displacement of the lifting scissor mechanism 18 and the lower sole part 8.

In other words, the transmission function of perpendicularly coupled scissor mechanisms is linear. Springs not shown in the diagram can be used to return the scissor mechanisms to their original position. The details of the perpendicularly coupled scissor mechanisms are discussed in FIG. 12 and FIG. 13. The drive scissor mechanism 19, via a system of pulleys 24, is connected by a rope 23 to a drive pulley 22, and the drive pulley 22 is connected to an electric motor 20 via a reduction gear 21. The electric motor 20 with a reduction gear 21, if there is not enough space in the sole, can be placed outside the sole. Due to this design of the motorized actuator, the rate of change of the height of the sole of the footwear is proportional to the speed of rotation of the electric motor. The speed control block diagram of the electric motor is shown in FIG. 15. The upper sole part 7 is flexible, divided into two parts and connected by means of hinges 25, the two pulleys 24 are arranged so that the rope 23 passing through the folding place of the upper sole part 7 is aligned with the twist axis 26 of the hinges 25, the transmission of the rope 23 through the folding place of the sole is illustrated in FIG. 14. In the lower part of the sole 8, both in the front and in the heel areas, flexible position detection means 11 for detecting contact with the support surface are installed, their length is about 25 mm and they react when they are bent or pressed. The position detection means 11 of this type enable to detect the support surface and to start and accelerate the electric motor 20 even before touching the support surface to the sole of the footwear. The control electronics that control the electric motor and the power supply can be mounted on the sole, and if there is not enough space, then mounted on the outside of the sole.

FIG. 12 shows perpendicularly coupled scissor mechanisms driven by an electric motor. The lifting scissor mechanism 18, which changes the height of the sole of the footwear and raises a person accordingly, is coupled to an analogous driving scissor mechanism 19, the lifting 18 and driving 19 scissor mechanisms moving in perpendicular planes. The lifting scissor 18 mechanism moves perpendicular to the plane 27 and the driving scissor 19 mechanism moves parallel to the plane 27. The drive scissor mechanism 19 is connected via a pulley system (not shown in this figure) to a rope 23 with a drive pulley 22 which is driven by an electric motor 20 via a reduction gear 21. The displacement of the rope 23 or the driving scissor mechanism 19 in the direction of the X axis is equal to the displacement of the lifting mechanism 18 in the direction of the Z axis, the transmission function is Z=X. Thus, if the motor 20 rotates at a constant speed, then the lifting mechanism 18 also changes the height of the sole at a constant speed. FIG. 12a shows a case where the lifting scissor mechanism 18 is of maximum height. FIG. 12b shows a case where the lifting scissor mechanism 18 is of the lowest height.

FIG. 13a and FIG. 13b show perpendicularly coupled scissor mechanisms with transmission functions Z=2 X and Z=1/2 X, respectively. FIG. 13a shows a driving scissor mechanism 19 in which the distances between the fulcrum points 29 are twice as small as the distances between the fulcrum points 28 in the lifting scissor mechanism 18. As a result, the lifting scissor mechanism 18 moves a distance twice as far as the driving scissor mechanism 19, the transmission function of the coupled scissor mechanisms is Z=2 X. FIG. 13b shows coupled scissor mechanisms in which the distances between the fulcrum points are equal, but the driving scissor mechanism 19 is double. As a result, the lifting scissor mechanism 18 moves at a distance twice as small as the driving scissor mechanism 19, in which case the transmission function of the coupled scissor mechanisms is Z=1/2 X.

FIG. 14 shows the passage of a rope between two pulleys 24 and 24′ when the angle between their rotation planes 30 and 30′ is freely variable. Since the upper sole part 7 of the footwear consists of two separate sole parts hinged 25, it is necessary to provide a means for passing the rope 23 between these two hinged and rotatable along pivot axis 26 parts of the sole. This is done by aligning the pivot axis 26 of the planes 30 and 30′ where the pulleys 24 and 24′ rotates with the rope 23 passed between said two adjacent pulleys 24 and 24′. By rotating the planes 30 and 30′ about the pivot axis 26, the rope 23 is twisted longitudinally, respectively, but the length of the rope between the adjacent pulleys 24 and 24′ remains unchanged, this feature enables two separate scissor mechanisms to be driven by one electric motor.

FIG. 15 shows a block diagram of the speed control of an electric motor which ensures a constant rotational speed of the motor regardless of its load. The motor 20 is controlled by an electronic speed controller 31, the rotational speed and power of the motor 20 depend mainly on the supply voltage or on the PWM duty cycle, when the motor 20 rotates without load, its rotational speed is indicated by the motor speed constant “KV”, which indicates the motor speed per volt. As the load increases, the motor speed decreases, so it is necessary to increase the voltage or PWM duty cycle to maintain a constant speed. For this purpose, a speed meter 32 is provided which, based on the signals received from the motor, determines the current motor speed and depending on whether the current speed coincides with the set speed, the electronic speed controller 31 adjusts the control voltage of the motor 20 or the PWM duty cycle. The motor rotational speed is set by an adjustable resistor 33 or other similar means. The current motor speed is determined by the output of the hall-effect sensors or through sensing the back electromotive force or back EMF, or by the signals output by the decoder. Also connected to the electronic speed controller 31 are position detection means 11 for detecting contact with the supporting surface, which control when to start and when to stop the motor 20. And there are also limit switches 34 and 34′ which switch when the sole of the footwear reaches a maximum and a minimum allowable height, respectively. When said switches are switched, the motor 20 is stopped immediately. The motor and control electronics are powered by a battery 10. Because the motor rotates at a given constant speed regardless of the load, and the perpendicularly coupled scissor mechanisms 18 and 19 have a linear transmission function, a constant rate of change of the height of the footwear sole and a correspondingly constant human lifting speed without any jerking are ensured.

1. A method to change dimensions of a sole of footwear in order to rise at least one foot of a person wearing the footwear comprising the steps of:
a) changing a height dimension of the sole of the footwear according to a position of the sole in contact with a supporting surface, where a height of the height dimension of the sole (6) of the footwear (5) of each foot is changed by increasing the height of the sole (6) from an initial position when the sole (6) of the footwear (5) is: at a predetermined distance from the supporting surface, the sole (6) already contacts the supporting surface, but still presses on the supporting surface with a force less than an acceptable predetermined force, or when the sole (6) is in contact with the supporting surface, the height of the sole at all different points in its plane increases uniformly and at a constant speed, regardless of a force exerted by the sole of the footwear on the supporting surface, raising the foot of the person upwards within the footwear;
b) stopping the increase of the height of the sole (6) and returning the sole (6) to the initial position when the sole (6) of the footwear (5) no longer touches the supporting surface;
wherein step a) and step b) are repeated when the person wearing the footwear walks, steps, runs, climbs, pedals, jumps on one foot, or jumps with both feet and where the change in the height dimension of the sole (6) of the footwear (5) of each foot creates an effect of an upward acting escalator without jerking.

2. A method to change dimensions of a sole of footwear in order to lower at least one foot of a person wearing the footwear comprising the steps of:
a) changing a height dimension of the sole of the footwear according to a position of the sole in contact with a supporting surface, where a height of the height dimension of the sole (6) of the footwear (5) of each foot is changed by decreasing a height of the sole (6) from an initial position when the sole (6) of the footwear (5) is: at a predetermined distance from the supporting surface, the sole (6) already contacts the supporting surface, but still presses on the supporting surface with a force less than an acceptable predetermined force, or when the sole is in contact with the supporting surface, the height of the sole at all different points in its plane decreases uniformly and at a constant speed, regardless of a force exerted by the sole of the footwear on the supporting surface, decreasing the foot of the person downwards within the footwear;
b) stopping the decrease of the height of the sole (6) and returning the sole to the initial position, when the sole (6) of the footwear (5) no longer touches the supporting surface;
wherein step a) and step b) are repeated when the person wearing the footwear walks, steps, runs, climbs, pedals, jumps on one foot, or jumps with both feet and where the change in the height dimension of the sole (6) of the footwear (5) of each foot creates an effect of a downward acting escalator without jerking.

3. The method of claim 2, wherein the height of the sole of the footwear varies when a vertical reaction force acting on the sole is less than 1% of body weight of the person, less than 5% of body weight of the person, less than 10% of body weight of the person, less than 20% of body weight of the person, less than 50% of body weight of the person, or less than 100% of body weight of the person.

4. The method of claim 2, wherein the height dimension of the sole of the footwear only varies in a direction of gravity, regardless of inclination of the supporting surface.

5. Footwear with variable sole dimensions, comprising:
a footwear body; and
a sole attached to the footwear body thereto, the sole having an upper sole part (7) and a lower sole part (8),
at least one motorized actuator mounted between the upper sole part (7) and the lower sole part (8) to change the dimensions of the sole according to the signals received from the position detectors for detecting contact with the supporting surface, control electronics, and a power supply; the at least one motorized actuator with a linear transmission function comprising a lifting scissor mechanism (18) which is coupled in a plane of motion perpendicular to the lifting scissor mechanism and kinematically interacts with an analogous driving scissor mechanism (19), in which distances between fulcrums (29) of the driving scissor mechanism (19) are equal to or twice less than distances between fulcrums (28) in the lifting scissor mechanism (18), the drive scissor mechanism (19) connected to a drive pulley (22) via a system of pulleys (24) and a rope (23), the drive pulley (22) being driven by a constant speed electric motor (20) with a reduction gear (21), such that when the lower part of the sole (8) is in contact with the supporting surface, the rotational speed of the electric motor (20) is kept constant regardless of any variation of load on the sole.

6. The footwear of claim 5, wherein the upper part (7) and the lower part (8) of the sole (6) of the footwear (5) each comprises at least two separate parts, wherein the at least two separate parts of the upper part (7) of the sole of the footwear are connected to each other by hinges (25) with a pivot axis (26).

7. The footwear of claim 5 wherein an angle between planes (30, 30 ‘) of rotation of two adjacent pulleys (24, 24’) is freely variable by aligning a pivot axis (26) of the planes (30, 30′) with the rope (23) connecting the two adjacent pulleys (24, 24′).

8. The footwear of claim 5, the rope (23) is a UFIMWPE rope or an aramid rope.

9. The footwear of claim 5, wherein the position detectors (11) are elongated in shape, are flexible and generate signals when the position detectors (11) are bent or compressed, the position detectors being (11) located in the lower part (8) of the sole.

10. The footwear of claim 5, wherein the electric motor (20) operates in a generator mode when the height of the sole (6) of the footwear (5) decreases under body weight of the person and performed gravity work is used to charge the power supply (10).

11. The method of claim 1, wherein the height of the sole of the footwear varies when a vertical reaction force acting on the sole is less than 1% of body weight of the person, less than 5% of body weight of the person, less than 10% of body weight of the person, less than 20% of body weight of the person, less than 50% of body weight of the person, or less than 100% of body weight of the person.

12. The method of claim 1, wherein the height dimension of the sole of the footwear only varies in a direction of gravity, regardless of inclination of the supporting surface.

13. The footwear of claim 6, wherein an angle between planes (30, 30′) of rotation of two adjacent pulleys (24, 24′) is freely variable by aligning a pivot axis (26) of the planes (30, 30′) with the rope (23) connecting the two adjacent pulleys (24, 24′).

14. The footwear of claim 6, wherein the rope (23) is a UFIMWPE rope or an aramid rope.

15. The footwear of claim 7, wherein the rope (23) is a UFIMWPE rope or an aramid rope.
